(19) United States
(12) Patent Application Publication
(10) Pub. No.: US 2023/0252822 A1
(43) Pub. Date: Aug. 10, 2023

(54) SIGN LANGUAGE DETECTION FOR SMART GLASSES

(71) Applicant: Meta Platforms Technologies, LLC, Menlo Park, CA (US)

(72) Inventors: Johana Gabriela Coyoc Escudero, Milpitas, CA (US); Scott Phillip Selfon, Kirkland, WA (US); Simon Porter, San Jose, CA (US); Christi Miller, Seattle, WA (US); Yao Ding, San Mateo, CA (US); Jonathan Y. Lee, Brooklyn, NY (US); Gregory Sarkis-Kelly, San Diego, CA (US); Brett Alden Lavalla, Eugene, OR (US); FNU Anurag Kumar, Bellevue, WA (US)

(21) Appl. No.: 18/163,420

(22) Filed: Feb. 2, 2023

Related U.S. Application Data
(60) Provisional application No. 63/306,854, filed on Feb. 4, 2022.
(60) Provisional application No. 63/323,901, filed on Mar. 25, 2022.
(60) Provisional application No. 63/348,392, filed on Jun. 2, 2022.

(51) Int. Cl. G06V 40/20; G09B 21/00

(52) U.S. Cl. CPC G06V 40/28; G09B 21/009

(57) ABSTRACT

A smart glass for incorporating speech recognition in an immersive reality environment is provided. The smart glass includes an eyepiece mounted on a frame including a transparent optical component to provide a user a view of a scene in a real world. The smart glass also includes a first camera configured to capture an image of a hand gesture from an interlocutor in the real world, and a processor configured to recognize, in the image of the hand gesture, a textual meaning. A system including memories storing instructions and processors to execute the instructions to perform methods for use of the above smart glass, and the methods, are also provided.

### CROSS-REFERENCE TO RELATED APPLICATIONS

The present disclosure is related and claims priority, under 35 U.S.C. §119(e), to U.S. Prov. Appln. No. 63/306,854, entitled INTERFACE IN SMART GLASSES AND VR/AR DEVICES FOR IMPAIRED USERS OR USERS WITH DISABILITIES, filed on Feb. 4, 2022, to U.S. Prov. Appln. No. 63/323,901, entitled INTERFACE IN SMART GLASSES AND VR/AR DEVICES FOR IMPAIRED USERS OR USERS WITH DISABILITIES, filed on Mar. 25, 2022, and to U.S. Prov. Appln. No. 63/348,392, entitled SIGN LANGUAGE DETECTION FOR SMART GLASSES, filed on Jun. 2, 2022, all to Johana Gabriela Coyoc ESCUDERO, et al, the contents of which applications are hereinafter incorporated by reference in their entirety, for all purposes.

### BACKGROUND

### Field

The present disclosure is directed to smart glasses to allow verbally impaired users to communicate seamlessly with others. More specifically, embodiments as disclosed herein are directed to smart glasses including sign language detection capabilities.

### Related Art

In the field of wearable devices, little attention is paid to users with disabilities in the assumption that they encompass a small portion of the market. However, the addition of technical features aiding users with special needs may open new applications that the general public may benefit from. In the case of verbally impaired users, sign language detection offers a challenging proposition, as complex, three-dimensional pattern recognition is desirable with high resolution (e.g., a few millimeters error in image recognition could render the effort moot) and at a relatively high pace (at least at an acceptable conversational speed). While achieving such features is not possible in current technologies, their implementation would open new possibilities not only for verbally impaired users, but rather the public at large.

### SUMMARY

In a first embodiment, a computer-implemented method, includes capturing, with a camera mounted on a headset, an image of a hand gesture from an interlocutor, recognizing, in the image of the hand gesture, a textual meaning from the interlocutor, and providing, to a user of the headset, the textual meaning from the interlocutor.

In a second embodiment, a headset includes an eyepiece mounted on a frame, including a transparent optical component to allow a user a view of a scene in a real world, a first camera configured to capture an image of a hand gesture from an interlocutor in the real world, and a processor configured to recognize, from the image of the hand gesture, a textual meaning.

In a third embodiment, a non-transitory, computer-readable medium stores instructions which, when executed by a processor, cause a computer to perform a method, including capturing, with a camera mounted on a headset, an image of a hand gesture from an interlocutor, recognizing, in the image of the hand gesture, a textual meaning from the interlocutor, and providing, to a user of the headset, the textual meaning from the interlocutor.

In yet other embodiments, a system includes a first means to store instructions, and a second means to execute the instructions and cause the system to perform a method, the method including capturing, with a camera mounted on a headset, an image of a hand gesture from an interlocutor, recognizing, in the image of the hand gesture, a textual meaning from the interlocutor, and providing, to a user of the headset, the textual meaning from the interlocutor.

These and other embodiments will be recognized by one of ordinary skill in the art in light of the following.

### BRIEF DESCRIPTION OF THE FIGURES

FIG. 1 illustrates an architecture including one or more wearable devices coupled to one another, to a mobile device, a remote server and to a database, according to some embodiments.

FIG. 2 illustrates a smart glass including at least two cameras to capture and interpret a sequence of hand gestures made by an interlocutor, to provide a textual content for the user, according to some embodiments.

FIG. 3 illustrates a smart glass including at least two cameras to capture and interpret a sequence of hand gestures made by an interlocutor, to provide an audio content for the user, according to some embodiments.

FIG. 4 is a flowchart illustrating steps in a method 400 for incorporating speech recognition in an immersive reality environment, according to some embodiments.

FIG. 5 is a block diagram illustrating an exemplary computer system with which headsets and other client devices, and the methods in FIGS. 10 and 11, can be implemented.

In the figures, elements having the same or similar label number have features and attributes related to the same or similar attributes, unless explicitly stated otherwise.

### DETAILED DESCRIPTION

In the following detailed description, numerous specific details are set forth to provide a full understanding of the present disclosure. It will be apparent, however, to one ordinarily skilled in the art, that embodiments of the present disclosure may be practiced without some of these specific details. In other instances, well-known structures and techniques have not been shown in detail so as not to obscure the disclosure.

Users having speech and hearing disabilities are typically left out of the market of electronic appliances such as networked wearable devices for immersive reality applications. This is mostly due to the challenges involved in bringing these devices up to speed with the needs of such users, such as the ability to recognize, interpret, and translate a large set of complex and intricate hand gestures in the real time of a conversation or an immersive reality environment.

Embodiments as disclosed herein provide technical solutions to the above technical problem arising in the realm of networked wearable devices for immersive reality applications. To do this, some embodiments use multiple sensors mounted on a headset or smart glass to capture two- or three-dimensional images of hand gestures. In addition, some embodiments take the advantage of fast networking strategies with paired mobile devices and networked servers to provide fast image collecting, processing, and response capabilities to resolve the above technical problems.

### Exemplary System Architecture

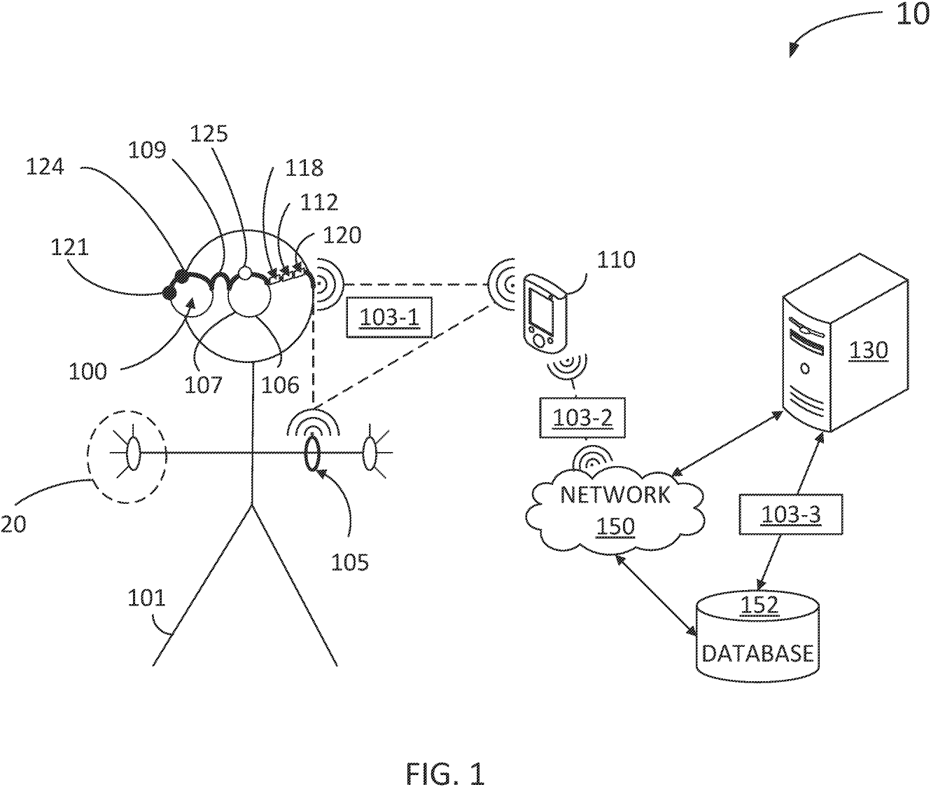

FIG. 1 illustrates an architecture 10 including one or more wearable devices (a smart glass 100 and a wristband device 105) coupled to one another, to a mobile device 110, a remote server 130 and to a database 152, according to some embodiments. Mobile device 110 may be a smart phone, all of which devices may communicate with one another via wireless communications and exchange a first dataset 103-1. Dataset 103-1 may include a recorded video, audio, or some other file or streaming media. The user 101 is also the owner or is associated with mobile device 110.

Mobile device 110 may be communicatively coupled with remote server 130 and database 152 via a network 150, and transmit/share information, files, and the like with one another (e.g., datasets 103-2 and 103-3).

In some embodiments, smart glass 100 may include a sensor 121 such as inertial measurement units (IMUs), gyroscopes, a microphone/speaker 124, cameras 125, and the like, mounted within a frame 109. Other sensors 121 that can be included in the wearable devices (e.g., smart glass 100, wrist-band 105, and the like) may be magnetometers, photodiodes, touch sensors, and other electromagnetic devices such as capacitive sensors, a pressure sensor, and the like. In some embodiments, smart glass 100 may include a display 107 on at least one eyepiece 106 to provide a model hand gesture to user 101, expressive of the speech from an interlocutor.

In addition, smart glass 100, or wrist-band 105, and any other wearable device, mobile device 110, server 130 and database 152 may include a memory circuit 120 storing instructions, and a processor circuit 112 configured to execute the instructions to cause smart glass 100 to perform, at least partially, some of the steps in methods consistent with the present disclosure. In some embodiments, memory 120 stores multiple hand gestures recognized for textual meaning for people with hearing disabilities.

In some embodiments, smart glass 100, wrist-band or wearable device 105, mobile device 110, server 130, and/or database 152 may further include a communications module 118 enabling the device to wirelessly communicate with remote server 130 via network 150. Smart glass 100 may thus download a multimedia online content (e.g., dataset 103-1) from remote server 130, to perform at least partially some of the operations in methods as disclosed herein. Network 150 may include, for example, any one or more of a local area network (LAN), a wide area network (WAN), the Internet, and the like. Further, the network can include, but is not limited to, any one or more of the following network topologies, including a bus network, a star network, a ring network, a mesh network, a star-bus network, tree or hierarchical network, and the like.

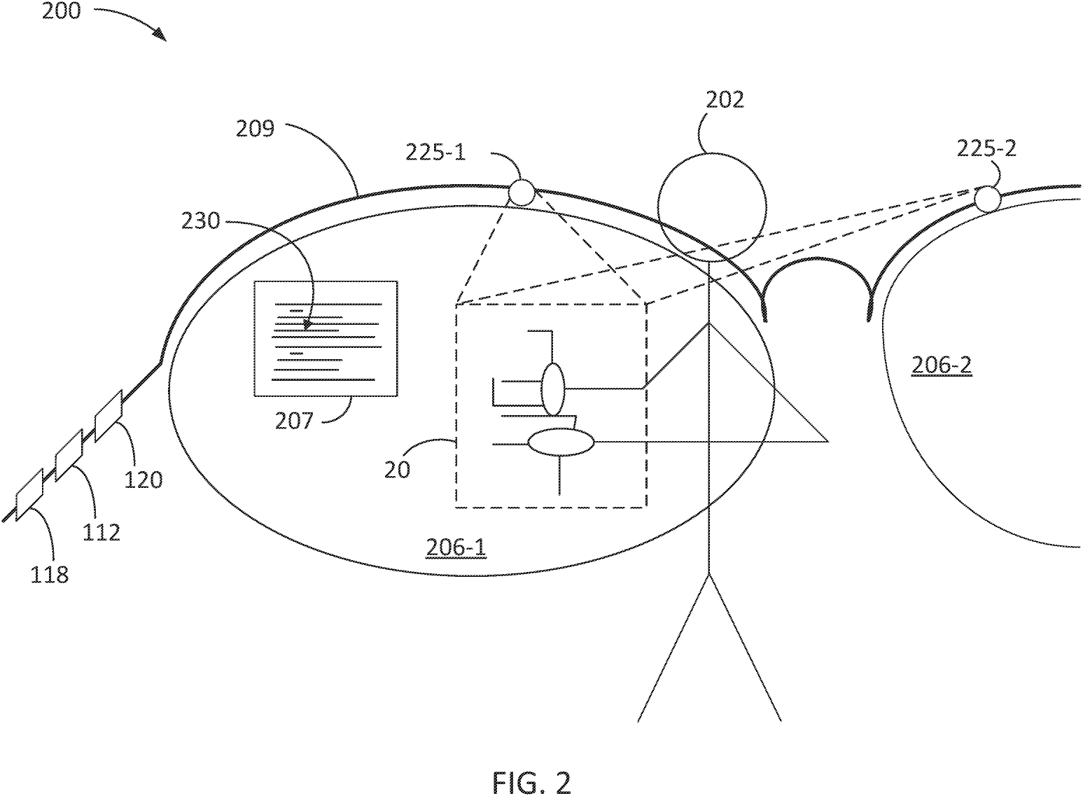

FIG. 2 illustrates a smart glass 200 including at least two cameras 225-1 and 225-2 (hereinafter, collectively referred to as “cameras 225”) to capture and interpret a sequence of hand gestures 20 made by an interlocutor 202, to provide a textual content 230 for the user, according to some embodiments. In some embodiments, second camera 225-2 is configured to capture a second image of hand gesture 20 of interlocutor 202 from a different angle of view relative to camera 225-1. Textual content 230 is provided through a display 207 in one of the eyepieces 206-1 and 206-2 (hereinafter, collectively referred to as “eyepieces 206”) of smart glass 200. Eyepieces 206 are mounted on a frame 209. Each eyepiece 206 includes a transparent optical component to allow the user a view of a scene in a real world. A memory 120 stores instructions that processor 112 executes to perform at least one or more steps in methods consistent with the present disclosure. In some embodiments, processor 112 may generate a three-dimensional (3D) reconstruction of hand gesture 20 using a stereoscopic view from cameras 225. Accordingly, processor 112 may be configured to recognize, in the image of hand gesture 20, a textual meaning. In some embodiments, smart glass 200 includes a communications module 118 configured to transmit the image of the hand gesture to a mobile device by the user (cf. mobile device 110).

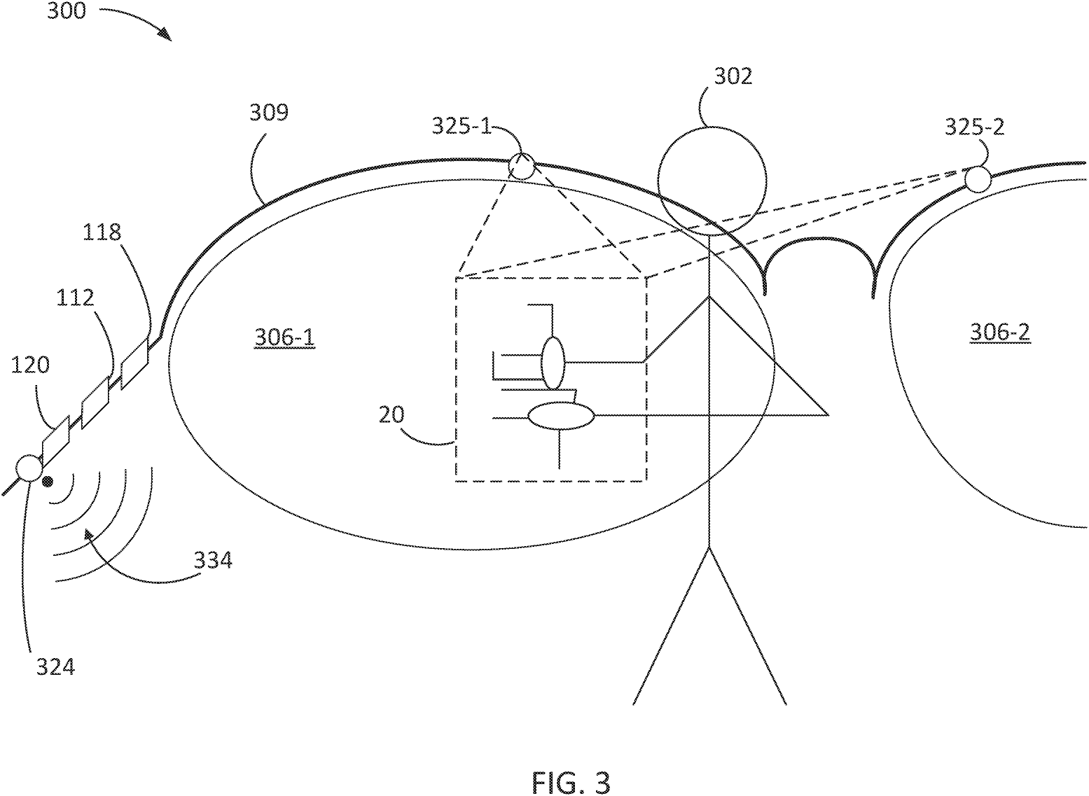

FIG. 3 illustrates a smart glass 300 including at least two cameras 325-1 and 325-2 (hereinafter, collectively referred to as “cameras 325”) to capture and interpret a sequence of hand gestures 20 made by an interlocutor 302, to provide an audio content 334 for the user, according to some embodiments. In some embodiments, camera 225-2 is configured to capture a second image of hand gesture 20 from a different angle of view from camera 325-1, to have a stereoscopic view. Audio content 334 is provided via a speaker 324 mounted on a frame 309 of smart glass 300.

Smart glass 300 includes one or more eyepieces 306-1 and 306-2 (hereinafter, collectively referred to as “eyepieces 306”) mounted on frame 309. Each eyepiece 306 includes a transparent optical component to allow a user a view of a scene in a real world. Smart glass 300 also includes a processor 112 configured to recognize, in the image of hand gesture 20, a textual meaning. A memory 120 stores instructions that processor 112 executes to perform at least one or more steps in methods consistent with the present disclosure. For example, in some embodiments processor 112 may generate a 3D model of hand gesture 20, based on the stereoscopic view provided by cameras 325. In some embodiments, smart glass 300 includes a communications module 118 configured to transmit the image or stereoscopic view of hand gesture 20 to a mobile device by the user (cf. mobile device 310). Speaker 324 is configured to provide audio content 334 to the user in response to the textual meaning of hand gesture 20 derived from processor 112.

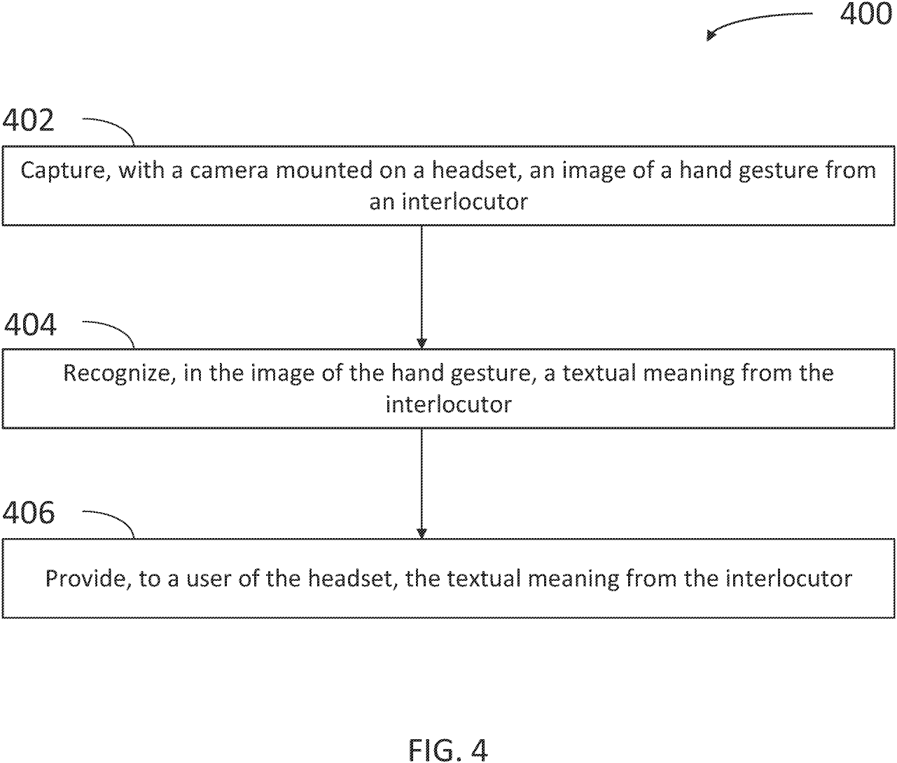

FIG. 4 is a flowchart illustrating steps in a method 400 for incorporating speech recognition in an immersive reality environment, according to some embodiments. In some embodiments, at least one or more of the steps in method 400 may be performed by a processor executing instructions stored in a memory in either one of a smart glass or other wearable device on a user’s body part (e.g., head, arm, wrist, leg, ankle, finger, toe, knee, shoulder, chest, back, and the like). In some embodiments, at least one or more of the steps in method 400 may be performed by a processor executing instructions stored in a memory, wherein either the processor or the memory, or both, are part of a mobile device for the user, a remote server or a database, communicatively coupled with each other via a network. Moreover, the mobile device, the smart glass, and the wearable devices may be communicatively coupled with each other via a wireless communication system and protocol (e.g., radio, Wi-Fi, Bluetooth, near-field communication -NFC- and the like). In some embodiments, a method consistent with the present disclosure may include one or more steps from method 400 performed in any order, simultaneously, quasi-simultaneously, or overlapping in time.

Step 402 includes capturing, with a camera mounted on a headset, an image of a hand gesture from an interlocutor. In some embodiments, step 402 includes receiving, from the user of the headset, an activation of a hand gesture recognition capability via a user interface in the headset. In some embodiments, step 402 includes capturing a stereoscopic image of the hand gesture. In some embodiments, step 402 includes capturing, with the camera mounted on a headset, an image of a hand gesture from the user. In some embodiments, step 402 includes forming a three-dimensional model of the hand gesture from a stereoscopic view from the camera.

Step 404 includes recognizing, in the image of the hand gesture, a textual meaning from the interlocutor. In some embodiments, step 404 includes identifying the hand gesture from a set of standard hand gestures for a hearing and voice impaired person. In some embodiments, step 404 includes forming a three-dimensional representation of the hand gesture based on the image. In some embodiments, step 404 includes recognizing, in the image of the hand gesture from the user, a textual meaning from the user. In some embodiments, step 406 includes recognizing, in the image of the hand gesture, a contextual meaning indicative of a state of mind of the interlocutor.

Step 406 incudes providing, to a user of the headset, the textual meaning from the interlocutor. In some embodiments, step 406 includes displaying the textual meaning for the user of the headset on a display in the headset. In some embodiments, step 406 includes providing an audio transcript of the textual meaning to the user via a microphone. In some embodiments, step 406 includes providing, to an interlocutor, the textual meaning from the user.

### Hardware Overview

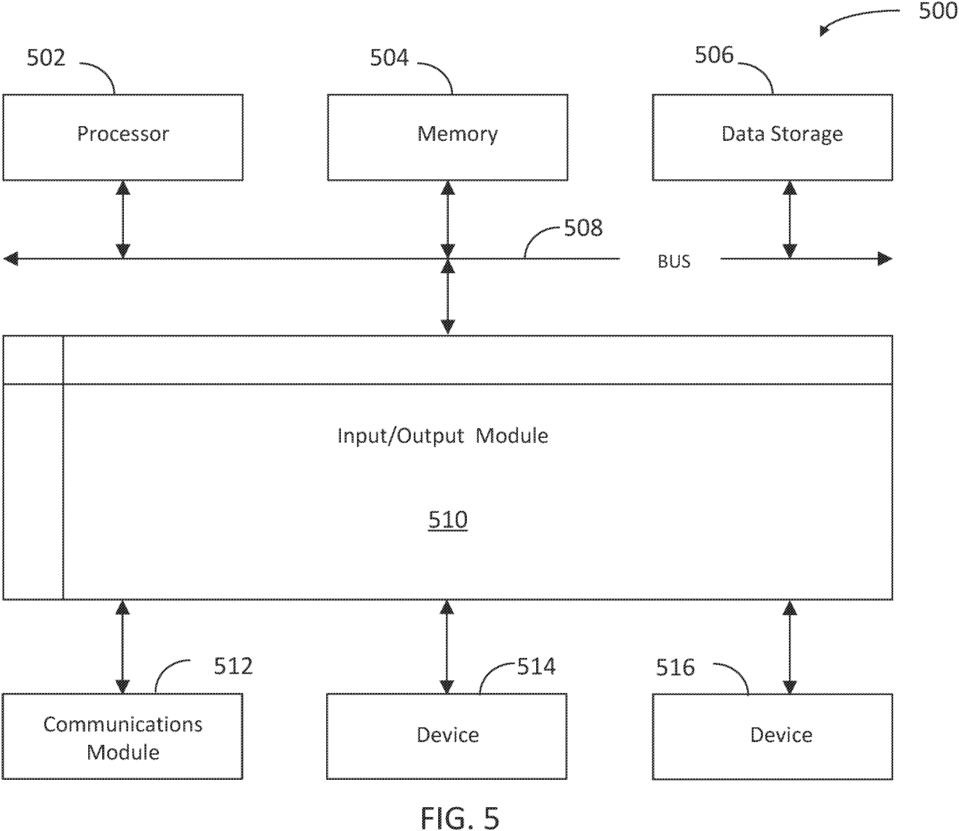

FIG. 5 is a block diagram illustrating an exemplary computer system 500 with which headsets and other client devices 110, and method 400 can be implemented, according to some embodiments. In certain aspects, computer system 500 may be implemented using hardware or a combination of software and hardware, either in a dedicated server, or integrated into another entity, or distributed across multiple entities. Computer system 500 may include a desktop computer, a laptop computer, a tablet, a phablet, a smartphone, a feature phone, a server computer, or otherwise. A server computer may be located remotely in a data center or be stored locally.

Computer system 500 includes a bus 508 or other communication mechanism for communicating information, and a processor 502 (e.g., processors 212) coupled with bus 508 for processing information. By way of example, the computer system 500 may be implemented with one or more processors 502. Processor 502 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 500 can include, in addition to hardware, code that creates an execution environment for the computer program in question, e.g., code that constitutes processor firmware, a protocol stack, a database management system, an operating system, or a combination of one or more of them stored in an included memory 504 (e.g., memories 220), such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled with bus 508 for storing information and instructions to be executed by processor 502. The processor 502 and the memory 504 can be supplemented by, or incorporated in, special purpose logic circuitry.

The instructions may be stored in the memory 504 and implemented in one or more computer program products, e.g., one or more modules of computer program instructions encoded on a computer-readable medium for execution by, or to control the operation of, the computer system 500, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, offside rule languages, procedural languages, reflective languages, rule-based languages, scripting languages, stack-based languages, synchronous languages, syntax handling languages, visual languages, wirth languages, and xml-based languages. Memory 504 may also be used for storing temporary variable or other intermediate information during execution of instructions to be executed by processor 502.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 500 further includes a data storage device 506 such as a magnetic disk or optical disk, coupled with bus 508 for storing information and instructions. Computer system 500 may be coupled via input/output module 510 to various devices. Input/output module 510 can be any input/output module. Exemplary input/output modules 510 include data ports such as USB ports. The input/output module 510 is configured to connect to a communications module 512. Exemplary communications modules 512 include networking interface cards, such as Ethernet cards and modems. In certain aspects, input/output module 510 is configured to connect to a plurality of devices, such as an input device 514 and/or an output device 516. Exemplary input devices 514 include a keyboard and a pointing device, e.g., a mouse or a trackball, by which a consumer can provide input to the computer system 500. Other kinds of input devices 514 can be used to provide for interaction with a consumer as well, such as a tactile input device, visual input device, audio input device, or brain-computer interface device. For example, feedback provided to the consumer can be any form of sensory feedback, e.g., visual feedback, auditory feedback, or tactile feedback; and input from the consumer can be received in any form, including acoustic, speech, tactile, or brain wave input. Exemplary output devices 516 include display devices, such as an LCD (liquid crystal display) monitor, for displaying information to the consumer.

According to one aspect of the present disclosure, headsets and client devices 110 can be implemented, at least partially, using a computer system 500 in response to processor 502 executing one or more sequences of one or more instructions contained in memory 504. Such instructions may be read into memory 504 from another machine-readable medium, such as data storage device 506. Execution of the sequences of instructions contained in main memory 504 causes processor 502 to perform the process steps described herein. One or more processors in a multi-processing arrangement may also be employed to execute the sequences of instructions contained in memory 504. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., a data server, or that includes a middleware component, e.g., an application server, or that includes a front end component, e.g., a client computer having a graphical consumer interface or a Web browser through which a consumer can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 500 can include clients and servers. A client and server are generally remote from each other and typically interact through a communication network. The relationship of client and server arises by virtue of computer programs running on the respective computers and having a client-server relationship to each other. Computer system 500 can be, for example, and without limitation, a desktop computer, laptop computer, or tablet computer. Computer system 500 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 502 for execution. Such a medium may take many forms, including, but not limited to, non-volatile media, volatile media, and transmission media. Non-volatile media include, for example, optical or magnetic disks, such as data storage device 506. Volatile media include dynamic memory, such as memory 504. Transmission media include coaxial cables, copper wire, and fiber optics, including the wires forming bus 508. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No claim element is to be construed under the provisions of 35 U.S.C. §112, sixth paragraph, unless the element is expressly recited using the phrase “means for” or, in the case of a method claim, the element is recited using the phrase “step for.”

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially described as such, one or more features from a described combination can in some cases be excised from the combination, and the described combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the described subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately described subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A computer-implemented method, comprising:
capturing, with a camera mounted on a headset, an image of a hand gesture from an interlocutor;
recognizing, in the image of the hand gesture, a textual meaning from the interlocutor; and
providing, to a user of the headset, the textual meaning from the interlocutor.

2. The computer-implemented method of claim 1, wherein capturing an image of a hand gesture comprises receiving, from the user of the headset, an activation of a hand gesture recognition capability via a user interface in the headset.

3. The computer-implemented method of claim 1, wherein capturing an image of a hand gesture comprises capturing a stereoscopic image of the hand gesture.

4. The computer-implemented method of claim 1, wherein capturing the image of the hand gesture comprises forming a three-dimensional model of the hand gesture from a stereoscopic view from the camera.

5. The computer-implemented method of claim 1, wherein recognizing the textual meaning comprises identifying the hand gesture from a set of standard hand gestures for a hearing and voice impaired person.

6. The computer-implemented method of claim 1, wherein recognizing the textual meaning comprises forming a three-dimensional representation of the hand gesture based on the image.

7. The computer-implemented method of claim 1, further comprising recognizing, in the image of the hand gesture, a contextual meaning indicative of a state of mind of the interlocutor.

8. The computer-implemented method of claim 1, wherein providing the textual meaning comprises displaying the textual meaning for the user of the headset on a display in the headset.

9. The computer-implemented method of claim 1, wherein providing the textual meaning comprises providing an audio transcript of the textual meaning to the user via a microphone.

10. The computer-implemented method of claim 1, further comprising capturing, with the camera mounted on a headset, an image of a hand gesture from the user; recognizing, in the image of the hand gesture from the user, a textual meaning from the user; and providing, to an interlocutor, the textual meaning from the user.

11. A headset, comprising:
an eyepiece mounted on a frame, including a transparent optical component to allow a user a view of a scene in a real world;
a first camera configured to capture an image of a hand gesture from an interlocutor in the real world; and
a processor configured to recognize, from the image of the hand gesture, a textual meaning.

12. The headset of claim 11, further comprising a communications module configured to transmit the image of the hand gesture to a mobile device by the user.

13. The headset of claim 11, further comprising a display on the eyepiece configured to provide the textual meaning to the user of the headset.

14. The headset of claim 11, wherein the first camera is configured to capture a second image of a hand gesture responsive to the textual meaning, and the processor is configured to recognize, from the second image, a textual meaning of the user.

15. The headset of claim 11, further comprising a speaker mounted on the frame and configured to provide, in response to the textual meaning from the processor, an audio content of the textual meaning to the user of the headset.

16. The headset of claim 11, further comprising a second camera configured to capture a second image of the hand gesture of the interlocutor from a different angle of view.

17. The headset of claim 11, further comprising a microphone to capture a speech from the interlocutor, and a display on the eyepiece to provide a model hand gesture to the user expressive of the speech from the interlocutor.

18. The headset of claim 11, further comprising a communications module configured to provide the image of the hand gesture to a mobile device with the user, for further image processing.

19. The headset of claim 11, further comprising a communications module configured to provide the image of the hand gesture to a remote server, for further image processing.

20. The headset of claim 11, further comprising a memory storing multiple hand gestures recognized for textual meaning for people with hearing disabilities.
